(19) United States
(12) Patent Application Publication
(10) Pub. No.: US 2026/0125084 A1
(43) Pub. Date: May 7, 2026

(54) Transport Facility

(71) Applicant: Daifuku Co., Ltd., Osaka-shi (JP)

(72) Inventors: Shuei Seno, Hinocho (JP); Hiroki Omoto, Hinocho (JP)

(21) Appl. No.: 19/115,298

(22) PCT Filed: Sep. 22, 2023
(86) PCT No.: PCT/JP2023/034436

§ 371 Date: Mar. 26, 2025

(30) Foreign Application Priority Data
Sep. 27, 2022 (JP) 2022-153930

(51) Int. Cl. B61B 13/00; B61G 1/32; B61J 3/12

(52) U.S. Cl. CPC B61B 13/00; B61G 1/32; B61J 3/12

(57) ABSTRACT

A transport facility includes: a carriage (2); an automated transport vehicle (3) configured to be coupled to the carriage (2) to move the carriage (2); and a controller configured to control an operation of the automated transport vehicle (3). The carriage (2) includes a body (21), and engagement sections (27) provided separately at a plurality of locations of the body (21). The automated transport vehicle (3) includes an engaging section configured to be engaged with one of the plurality of engagement sections (27). The controller determines, according to a movement mode of the carriage (2), the engagement section (27) with which the engaging section is to be engaged, from among the plurality of engagement sections (27).

### CROSS-REFERENCE TO RELATED APPLICATIONS

This application is the United States national phase of International Patent Application No. PCT/JP 2023/034436 filed Sep. 22, 2023, and claims priority to Japanese Patent Application No. 2022-153930 filed Sep. 27, 2022, the disclosures of which are hereby incorporated by reference in their entireties.

### BACKGROUND OF THE INVENTION

### Field of the Invention

The present invention relates to a transport facility.

### Description of Related Art

For example, parts may be transported and assembled in a factory or the like on a carriage that moves along a floor surface. At that time, an automated transport vehicle may be used to move the carriage. In this case, the factory or the like is equipped with a transport facility for transporting the carriage. An example of such a transport facility is disclosed in JP 2007-76518A.

The transport facility according to JP 2007-76518A includes carriages (carriages A to G), and automated transport vehicles (automated transport devices x to z) that move the carriages as a result of being self-propelled while being coupled to the carriages. In the transport facility according to JP 2007-76518A, the automated transport vehicles are each configured to be coupled to a carriage by engaging an engaging section (a hook pin 103) with an engaged portion (pin engaging hole 49) provided in the carriage.

In the transport facility of JP 2007-76518A, the coupling positions between the automated transport vehicles and the carriages are uniformly positions in the vicinity of the center of the carriages (specifically, located at the center and slightly closer to the front side). Such a configuration is considered to enable the carriages to be moved stably on average when the automated transport vehicles are self-propelled. However, in relation to the movement mode of the carriages (e.g., the movement direction, the movement speed, etc., of the carriages), the driving force of the automated transport vehicles cannot be necessarily transmitted appropriately to the carriages. This may result in inefficient movement of the carriages.

### SUMMARY OF THE INVENTION

Therefore, it is desired to efficiently move a carriage in a transport facility having a configuration in which the carriage is moved by an automated transport vehicle.

A transport facility according to the present disclosure includes:
a carriage;
an automated transport vehicle configured to be coupled to the carriage to move the carriage; and
a controller configured to control an operation of the automated transport vehicle, wherein
the carriage includes a body, and engagement sections provided separately at a plurality of locations of the body,
the automated transport vehicle includes an engaging section configured to be engaged with one of the plurality of engagement sections for coupling between the automated transport vehicle and the carriage, and
the controller determines, according to at least either a state of the carriage or a movement mode of the carriage, a target engagement section serving as the engagement section with which the engaging section is to be engaged, from among the plurality of engagement sections.

With this configuration, the engagement sections of the carriage are provided separately at a plurality of locations of the body, a target engagement section is determined from among the plurality of engagement sections, and the engaging section of the automated transport vehicle is engaged with the target engagement section. In determining the target engagement section, the movement mode of the carriage are taken into consideration. For example, in relation to the moving direction, the movement speed, and so forth of the carriage, the carriage and the automated transport vehicle can be easily coupled at an optimal position in terms of efficient driving power transmission. This allows the driving force of the automated transport vehicle to be appropriately transmitted to the carriage according to the movement mode of the carriage. Thus, it is possible to efficiently move a carriage in a transport facility having a configuration in which the carriage is moved by an automated transport vehicle.

Further features and advantages of the present disclosure will become apparent from the following description of illustrative and non-limiting embodiments with reference to the drawings.

### BRIEF DESCRIPTION OF THE DRAWINGS

FIG. 1 is a diagram showing a layout of a transport facility according to an embodiment.

FIG. 2 is a side view of a carriage and an automated transport vehicle.

FIG. 3 is a front view of the carriage and the automated transport vehicle.

FIG. 4 is a plan view of the carriage and the automated transport vehicle.

FIG. 5 is a side view of the automated transport vehicle.

FIG. 6 is a schematic diagram illustrating coupling modes between the carriage and the automated transport vehicle.

FIG. 7 is a plan view of the carriage traveling straight and the automated transport vehicle.

FIG. 8 is a plan view of the carriage traveling straight at a high speed and the automated transport vehicle.

FIG. 9 is a plan view of the carriage traveling reversely and the automated transport vehicle.

FIG. 10 is a plan view of the carriage traveling along a curve and the automated transport vehicle.

FIG. 11 is a plan view of the carriage traveling along a curve at a high speed and the automated transport vehicle.

FIG. 12 is a plan view of the carriage traveling transversely and the automated transport vehicle.

FIG. 13 is a plan view of the carriage traveling transversely and the automated transport vehicle.

FIG. 14 is a plan view of the carriage traveling obliquely and the automated transport vehicle.

FIG. 15 is a plan view of the carriage traveling obliquely and the automated transport vehicle.

FIG. 16 is a plan view of the carriage traveling to make a short turn and the automated transport vehicle.

FIG. 17 is a plan view of the carriage traveling straight and the automated transport vehicle.

FIG. 18 is a plan view of the carriage traveling transversely and the automated transport vehicle.

FIG. 19 is a plan view of the carriage traveling along a platform and the automated transport vehicle.

FIG. 20 is a plan view of a carriage and an automated transport vehicle according to another embodiment.

FIG. 21 is a plan view of a carriage and an automated transport vehicle according to another embodiment.

### DESCRIPTION OF THE INVENTION

An embodiment of the transport facility will be described with reference the drawings. When used, a transport facility 1 according to the present embodiment is installed in a factory in which transport and assembly of parts are carried out on carriages 2 moving along a floor surface F. As an example, the transport facility 1 can be used in an automobile manufacturing plant in which automobiles are assembled by successively attaching various parts to automobile bodies placed on the carriage 2 while the carriages 2 are moved along the floor surface F.

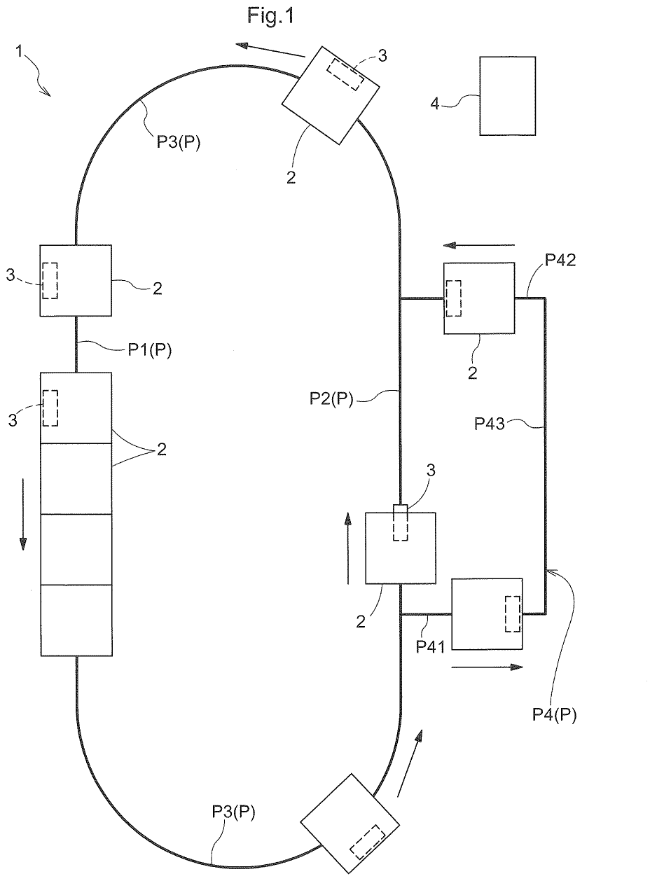

As shown in FIG. 1, the transport facility 1 includes a plurality of carriages 2, a plurality of automated transport vehicles 3, and a controller 4. The automated transport vehicles 3 are controlled by the controller 4, and are self-propelled along a transport path P. Each carriage 2 moves along the transport path P together with an automated transport vehicle 3 while being coupled to the automated transport vehicle 3.

Here, the transport path P is a path along which each carriage 2 and a placement target object B (e.g., an automobile body) placed thereon are transported. The transport path P may be a path determined in advance with the use of physical means such as a rail, or a path determined each time by software with the use of guiding means such as magnetic markers, light reflecting tape, electromagnetic induction cables, or two-dimensional markers.

The transport path P of the present embodiment includes a first straight section P1, a second straight section P2, curved sections P3, and a bypass section P4. The first straight section P1 and the second straight section P2 are arranged parallel to each other and are connected to each other by the curved sections P3 at both ends of each straight section. The bypass section P4 is provided to allow bypassing a portion of the second straight section P2, and includes a first transverse section P41 and a second transverse section P42 connected to the second straight section P2, and a straight section P43 connecting the first transverse section P41 and the second transverse section P42.

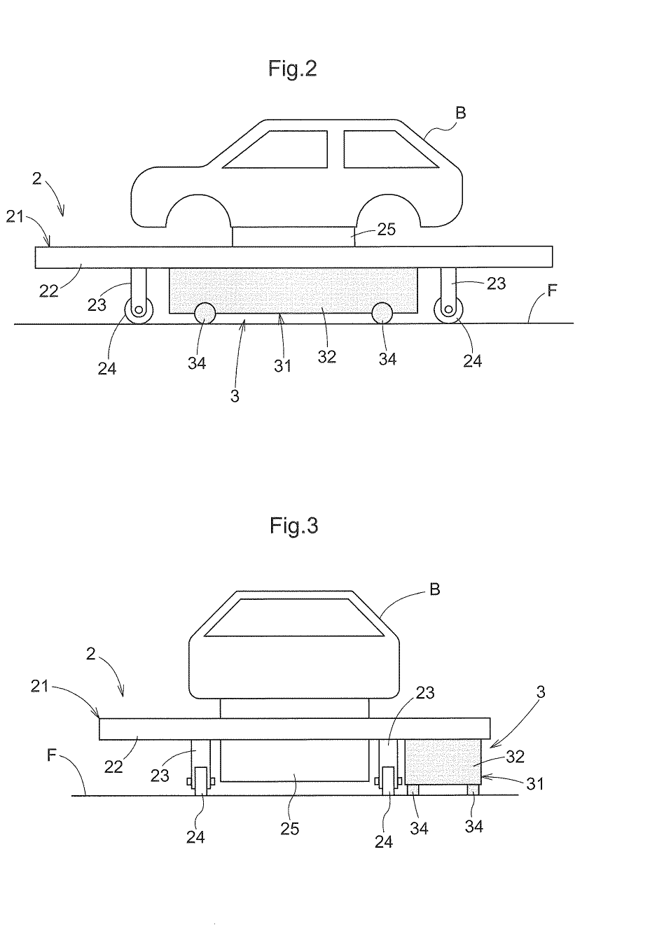

As shown in FIGS. 2 to 4, each carriage 2 of the present embodiment includes a body 21, a lifting device 25, and engagement sections 27. The body 21 includes a placement table 22, support columns 23, and wheels 24.

The placement table 22 is a table configured to place the placement target object B thereon. The placement table 22 need not necessarily always be in the state of placement as long at least the placement target object B can be placed thereon. For example, in a case where each carriage 2 includes a lifting device 25 as in the present embodiment, the placement target object B may be lifted by the lifting device 25 (see FIGS. 2 and 3). Such a mode is covered by the concept “to place the placement target object B thereon”. The placement table 22 is formed in a square shape in plan view (more specifically, a rectangular shape in plan view) that is larger than the placement target object.

The support columns 23 extend downward from the placement table 22. Four support columns 23 are provided, and are arranged separately on the left and right sides at forward portions and rearward portions of the placement table 22. Also, a wheel 24 is fixed to a lower end portion of each of the support columns 23. In the present embodiment, the wheels 24 are casters.

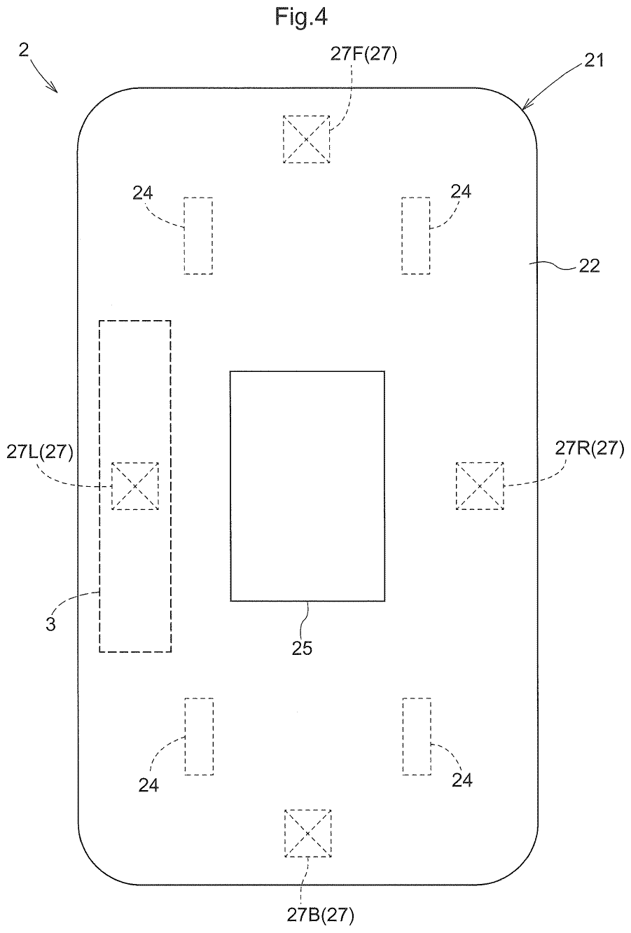

As shown in FIG. 4, the lifting device 25 is provided at a central portion of the placement table 22. The lifting device 25 is provided in a region surrounded by the four wheels 24 (the four support columns 23) in plan view. The lifting device 25 lifts and lowers a placement target object B while supporting the placement target object B from below. When each carriage 2 includes the lifting device 25, an operation such as assembling can be performed in a state in which the placement target object B is lifted, and this results in improved workability.

Each engagement section 27 is a portion with which an engaging section 37, described below, provided in the automated transport vehicle 3 is engaged. In the present embodiment, a plurality of engagement sections 27 are provided. Also, the plurality of engagement sections 27 are provided separately at a plurality of locations of the body 21. In the present embodiment, four engagement sections 27 are provided separately on the front, rear, left, and right sides of the body 21.

In the following, the four engagement sections 27 may be referred to as a “front engagement section 27F”, a “rear engagement section 27B”, a “right engagement section 27R”, and a “left engagement section 27L” to differentiate therebetween. The front engagement section 27F is an engagement section 27 provided on the front side of the body 21, and the rear engagement section 27B is an engagement section 27 provided on the rear side of the body 21. The right engagement section 27R is an engagement section 27 provided on the right side of the body 21, and the left engagement section 27L is an engagement section 27 provided on the left side of the body 21. Note that the front, rear, left, and right sides refer to orientations with reference to the moving direction of the carriages 2 during forward movement.

In the present embodiment, the engagement sections 27 are provided outside the region surrounded by the wheels 24 (the four support columns 23) in plan view. The front engagement section 27F is provided forward of a pair of left and right wheels 24 (support columns 23) located on the front side. The rear engagement section 27B is provided rearward of a pair of left and right wheels 24 (support columns 23) located on the rear side. The right engagement section 27R is provided rightward of a pair of front and rear wheels 24 (support columns 23) located on the right side. The left engagement section 27L is provided leftward of a pair of front and rear wheels 24 (support columns 23) located on the left side.

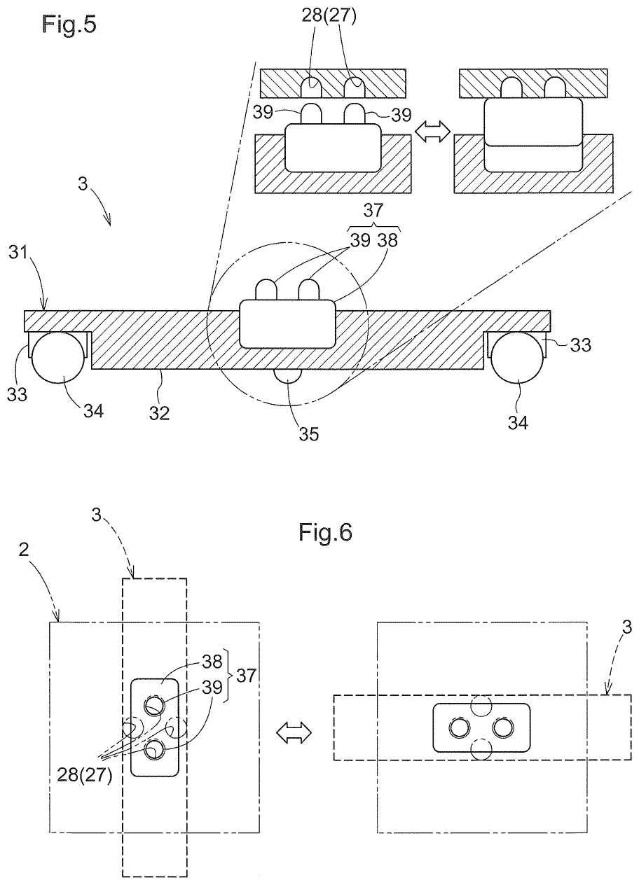

The engagement section s 27 are provided on the body 21 in such a manner as to face downward. In the present embodiment, the engagement sections 27 are constituted by pin engaging holes 28 formed in the lower surface of the placement table 22 in such a manner as to open downward. The pin engaging holes 28 may be blind holes as shown in FIG. 5, or vertically penetrating through holes.

In the present embodiment, the engagement sections 27 provided at various locations of the body 21 are constituted by a set of four pin engaging holes 28 as shown in FIG. 6. Two of the four pin engaging holes 28 are arranged side by side in the front-rear direction, and the remaining two are arranged side by side in the left-right direction at the center of a virtual line segment connecting these engaging holes in such a manner as to sandwich the virtual line segment.

The automated transport vehicles 3 are self-propelled along the transport path P. As shown in FIG. 5, each automated transport vehicle 3 includes a body 31 and an engaging section 37. The body 31 includes a main unit 32, drive units 33, driving wheels 34, and auxiliary wheels 35. When the transport path P is constituted with the use of guiding means such as magnetic markers, each automated transport vehicle 3 may also include other components, such as a marker reader, necessary for autonomous traveling.

The main unit 32 is a major portion constituting the body 31, and supports the drive units 33, the driving wheels 34, and the auxiliary wheels 35. As can be understood from FIGS. 3 to 5, the main unit 32 is formed in a vertically elongated shape having an overall length greater than an overall width in plan view.

The drive units 33 are supported at both ends, respectively, of the main unit 32 in the longitudinal direction. Each drive unit 33 incorporates, for example, a driving power source such as a motor, and rotates the driving wheels 34 by the driving force of the driving power source to achieve self-propelling. In the present embodiment, the two drive units 33 are each pivotably supported with respect to the main unit 32, and are independently steerable. The auxiliary wheels 35 are supported at a central portion of the main unit 32 in the longitudinal direction. In the present embodiment, the auxiliary wheels 35 are casters.

The engaging section 37 is a portion configured to be engaged with the engagement sections 27 provided on each carriage 2. The engaging section 37 is engaged with one of the plurality of engagement sections 27 (the front engagement section 27F, the rear engagement section 27B, the right engagement section 27R, and the left engagement section 27L) provided on each carriage 2. The automated transport vehicle 3 according to the present embodiment can switch the coupling position with the carriage 2 between a plurality of positions at which the engagement sections 27 are provided.

As shown in FIG. 5, the engaging section 37 is provided in such a manner as to be vertically movable relative to the main unit 32. The engaging section 37 includes a lifter 38 that is vertically movable relative to the main unit 32, and engaging pins 39 protruding upward from the lifter 38. In the present embodiment, the engaging section 37 is constituted by a set of two engaging pins 39 arranged side by side in the longitudinal direction of the body 21.

When the lifter 38 remains lowered at a lowered position relative to the main unit 32, the engaging pins 39 are not engaged with the pin engaging holes 28 constituting each engagement section 27 and are in a non-engaging state. Thus, the automated transport vehicle 3 and the carriage 2 are in a decoupled state.

On the other hand, when the lifter 38 is lifted to a lifted position relative to the main unit 32, the engaging pins 39 enter and engage with the pin engaging holes 28 constituting the engagement section 27. Thus, the automated transport vehicle 3 and the carriage 2 are in a coupled state. Then, the automated transport vehicle 3 moves the carriage 2 along the transport path P as a result of being self-propelled along the transport path P while being coupled to the carriage 2.

As described above, in the present embodiment, one engagement section 27 is constituted by the set of four pin engaging holes 28 arranged side by side in the front-rear direction and the left-right direction. The interval between the set of two engaging pins 39 is equal to the interval between a set of two pin engaging holes 28 arranged side by side in the front-rear direction, and is also equal to the interval between a set of two pin engaging holes 28 arranged side by side in the left-right direction.

As a result of the set of two engaging pins 39 being engaged with the set of two pin engaging holes 28 arranged side by side in the front-rear direction, each automated transport vehicle 3 is coupled to the carriage 2 in an orientation in which the longitudinal direction of the automated transport vehicle 3 extends in the front-rear direction of the carriage 2 (the left side in FIG. 6). As a result of the set of two engaging pins 39 being engaged with the set of two pin engaging holes 28 arranged side by side in the left-right direction, the automated transport vehicle 3 is coupled to the carriage 2 in an orientation in which the longitudinal direction of the automated transport vehicle 3 extends in the left-right direction of the carriage 2 (the right side in FIG. 6). In this manner, the automated transport vehicle 3 according to the present embodiment can switch the coupling orientation with the carriage 2 between a longitudinal orientation (an orientation extending in the front-rear direction) and a transverse orientation (an orientation extending in the left-right direction).

The controller 4 controls operations of the automated transport vehicles 3. The controller 4 controls the traveling speed (the rotation speed of the driving wheels 34), the steering (the orientations of the drive units 33), and so forth of each automated transport vehicle 3, according to, for example, the position in the transport path P of the automated transport vehicle 3. In the present embodiment, the controller 4 determines, according to the movement mode of the carriage 2, an engagement section 27 (hereinafter referred to as a “target engagement section 27T”) with which the engaging section 37 is to be engaged, from among the plurality of engagement sections 27. Also, the controller 4 controls the traveling of the body 31 and the lifting/lowering of the engaging section 37 in such a manner as to engage the engaging section 37 with the determined target engagement section 27T.

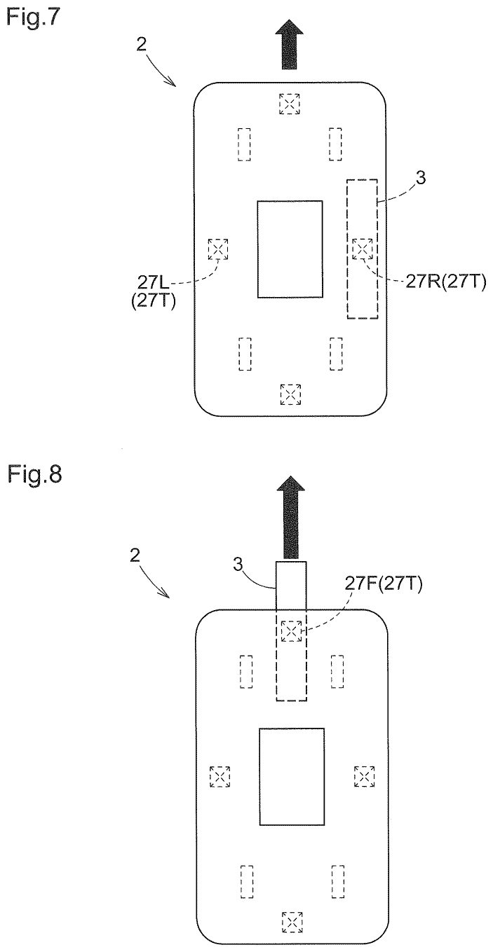

FIG. 7 shows an example of a case where a carriage 2 travels straight at a speed less than a predetermined reference speed. For example, this corresponds to a case where the carriage 2 travels along the first straight section P1 or the straight section P43 of the bypass section P4 in the example shown in FIG. 1. Here, the reference speed is the traveling speed of the carriage 2 that is set taking the safety, the workability, and so forth into account, and is set to, for example, a speed of about 30 to 50 m/min. The reference speed may have a fixed value, or a variable value that varies depending on the situation.

As shown in FIG. 7, in a case where the carriage 2 travels straight at a speed less than the reference speed (in other words, in a case where the controller 4 is to cause the automated transport vehicle 3 to move the carriage 2 straight at a speed less than the reference speed), the controller 4 determines, from among the plurality of engagement sections 27, the right engagement section 27R or the left engagement section 27L as the target engagement section 27T. Then, the automated transport vehicle 3 is coupled to the carriage 2 at a position on the right side of the left side of the body 21. Note that FIG. 7 shows, as a representative example, how the automated transport vehicle 3 and the carriage 2 are coupled to each other on the right side.

In the example shown in FIG. 7, the automated transport vehicle 3 entirely overlaps the carriage 2 in plan view in a state in which the engaging section 37 is engaged with the right engagement section 27R provided on the body 21, and in which the longitudinal direction of the automated transport vehicle 3 extends in the front-rear direction of the carriage 2. Similarly, in a case where the left engagement section 27L is determined as the target engagement section 27T, the automated transport vehicle 3 entirely overlaps the carriage 2 in plan view in a state in which the engaging section 37 is engaged with the left engagement section 27L provided on the body 21, and in which the longitudinal direction of the automated transport vehicle 3 extends in the front-rear direction of the carriage 2.

FIG. 8 shows an example of a case where the carriage 2 travels straight at a speed greater than or equal to a predetermined reference speed. For example, this corresponds to a case where the carriage 2 travels along the second straight section P2 in the example shown in FIG. 1. Here, the reference speed is set as described above.

As shown in FIG. 8, in a case where the carriage 2 travels straight at a speed greater than or equal to the reference speed (in other words, in a case where the controller 4 is to cause the automated transport vehicle 3 to move the carriage 2 straight at a speed greater than or equal to the reference speed), the controller 4 determines, from among the plurality of engagement sections 27, the front engagement section 27F as the target engagement section 27T. Then, the automated transport vehicle 3 is coupled to the carriage 2 at a position on the front side of the body 21.

In the example shown in FIG. 8, the engaging section 37 and the front engagement section 27F are engaged with each other in a state in which the longitudinal direction of the automated transport vehicle 3 extends in the front-rear direction of the carriage 2. The automated transport vehicle 3 only partially overlaps the carriage 2 in plan view, and a part of the front side of the automated transport vehicle 3 does not overlap the carriage 2 in plan view.

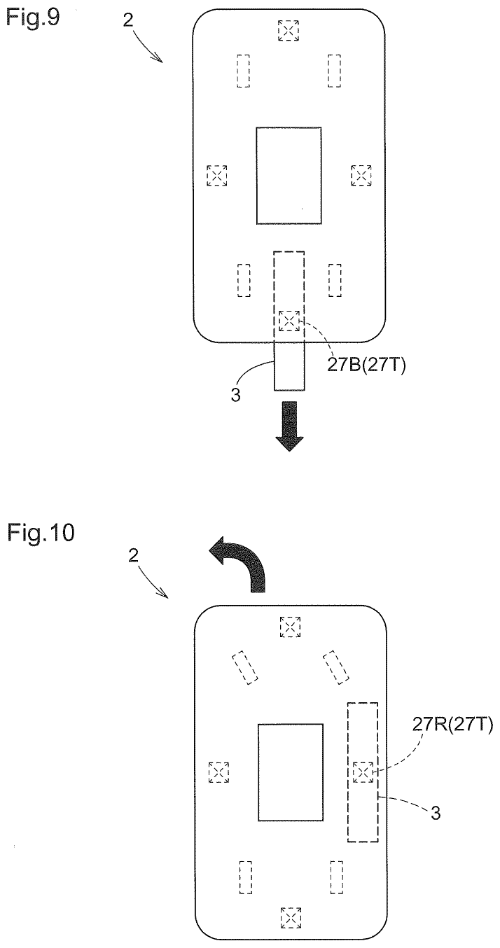

FIG. 9 shows an example of a case where the carriage 2 travels reversely. As illustrated in this drawing, in a case where the carriage 2 travels reversely (in other words, in a case where the controller 4 is to cause the automated transport vehicle 3 to move the carriage 2 reversely), the controller 4 determines, from among the plurality of engagement sections 27, the rear engagement section 27B as the target engagement section 27T. Then, the automated transport vehicle 3 is coupled to the carriage 2 at a position on the rear side of the body 21.

In the example shown in FIG. 9, the engaging section 37 and the rear engagement section 27B are engaged with each other in a state in which the longitudinal direction of the automated transport vehicle 3 extends in the front-rear direction of the carriage 2. The automated transport vehicle 3 only partially overlaps the carriage 2 in plan view, and a part of the rear side of the automated transport vehicle 3 does not overlap the carriage 2 in plan view.

FIG. 10 shows an example of a case where the carriage 2 travels leftward along a curve at a speed less than a predetermined reference speed. For example, this corresponds to a case where the carriage 2 travels along the curved section P3 in the example shown in FIG. 1. Here, the reference speed is set as described above.

As shown in FIG. 10, in a case where the carriage 2 travels leftward along a curve at a speed less than the reference speed (in other words, in a case where the controller 4 is to cause the automated transport vehicle 3 to move the carriage 2 leftward along a curve at a speed less than the reference speed), the controller 4 determines, from among the plurality of engagement sections 27, the right engagement section 27R, which is the engagement section 27 located opposite to the direction of the curve, as the target engagement section 27T. Then, the automated transport vehicle 3 is coupled to the carriage 2 at a position on the right side of the body 21. In the example shown in FIG. 10, the automated transport vehicle 3 entirely overlaps the carriage 2 in plan view in a state in which the engaging section 37 is engaged with the right engagement section 27R provided on the body 21, and in which the longitudinal direction of the automated transport vehicle 3 extends in the front-rear direction of the carriage 2.

Note that in a case where the carriage 2 travels rightward along a curve at a speed less than the reference speed (in other words, in a case where the controller 4 is to cause the automated transport vehicle 3 to move the carriage 2 rightward along a curve at a speed less than the reference speed), the controller 4 determines, from among the plurality of engagement sections 27, the left engagement section 27L, which is the engagement section 27 located opposite to the direction of the curve, as the target engagement section 27T. Then, the automated transport vehicle 3 is coupled to the carriage 2 at a position on the left side of the body 21. At this time, the automated transport vehicle 3 entirely overlaps the carriage 2 in plan view in a state in which the engaging section 37 is engaged with the left engagement section 27L provided on the body 21, and in which the longitudinal direction of the automated transport vehicle 3 extends in the front-rear direction of the carriage 2.

Note that in a case where the carriage 2 travels in an S-shape at a speed less than the reference speed (in other words, in a case where the controller 4 is to cause the automated transport vehicle 3 to move the carriage 2 in an S-shape at a speed less than the reference speed), the controller 4 switches the target engagement section 27T according to the position of the carriage 2 in the transport path P in such a manner as to use an engagement section 27 located opposite to the direction of the next curve as the target engagement section 27T.

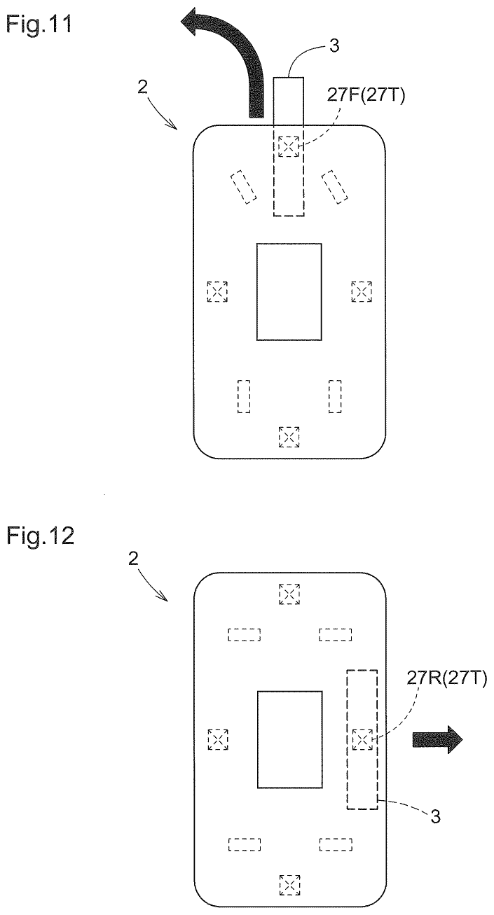

FIG. 11 shows an example of a case where the carriage 2 travels leftward along a curve at a speed greater than or equal to a predetermined reference speed. Here, the reference speed is set as described above.

As shown in FIG. 11, in a case where the carriage 2 travels leftward at a speed greater than or equal to the reference speed (in other words, in a case where the controller 4 is to cause the automated transport vehicle 3 to move the carriage 2 leftward at a speed greater than or equal to the reference speed), the controller 4 determines, from among the plurality of engagement sections 27, the front engagement section 27F as the target engagement section 27T. That is, even in a case where the carriage 2 travels leftward along a curve, in a case where the traveling speed is greater than or equal to the reference speed, the controller 4 determines, in place of the above-described right engagement section 27R, the front engagement section 27F as the target engagement section 27T. Then, the automated transport vehicle 3 is coupled to the carriage 2 at a position on the front side of the body 21.

In the example shown in FIG. 11, the engaging section 37 and the front engagement section 27F are engaged with each other in a state in which the longitudinal direction of the automated transport vehicle 3 extends in the front-rear direction. The automated transport vehicle 3 only partially overlaps the carriage 2 in plan view, and a part of the front side of the automated transport vehicle 3 does not overlap the carriage 2 in plan view.

Note that in a case where the carriage 2 travels rightward along a curve at a speed greater than or equal to the reference speed (in other words, in a case where the controller 4 is to cause the automated transport vehicle 3 to move the carriage 2 rightward at a speed greater than or equal to the reference speed), the controller 4 determines, from among the plurality of engagement sections 27, the front engagement section 27F as the target engagement section 27T. That is, even in a case where the carriage 2 travels rightward along a curve, in a case where the traveling speed is greater than or equal to the predetermined reference speed, the controller 4 determines, in place of the above-described left engagement section 27L, the front engagement section 27F as the target engagement section 27T. Then, the automated transport vehicle 3 is coupled to the carriage 2 at a position on the front side of the body 21. The automated transport vehicle 3 only partially overlaps the carriage 2 in plan view, and a part of the front side of the automated transport vehicle 3 does not overlap the carriage 2 in plan view.

FIG. 12 shows an example of a case where the carriage 2 travels transversely rightward. For example, this corresponds to a case where the carriage 2 travels along the first transverse section P41 of the bypass section P4 in the example shown in FIG. 1.

As shown in FIG. 12, in a case where the carriage 2 travels transversely rightward (in other words, in a case where the controller 4 is to cause the automated transport vehicle 3 to move the carriage 2 transversely rightward), the controller 4 determines, from among the plurality of engagement sections 27, the right engagement section 27R, which is the engagement section 27 located closer to the moving direction during the transverse traveling, as the target engagement section 27T. Then, the automated transport vehicle 3 is coupled to the carriage 2 at a right-side position of the body 21. In the example shown in FIG. 12, the automated transport vehicle 3 entirely overlaps the carriage 2 in plan view in a state in which the engaging section 37 is engaged with the right engagement section 27R provided on the body 21, and in which the longitudinal direction of the automated transport vehicle 3 extends in the front-rear direction of the carriage 2.

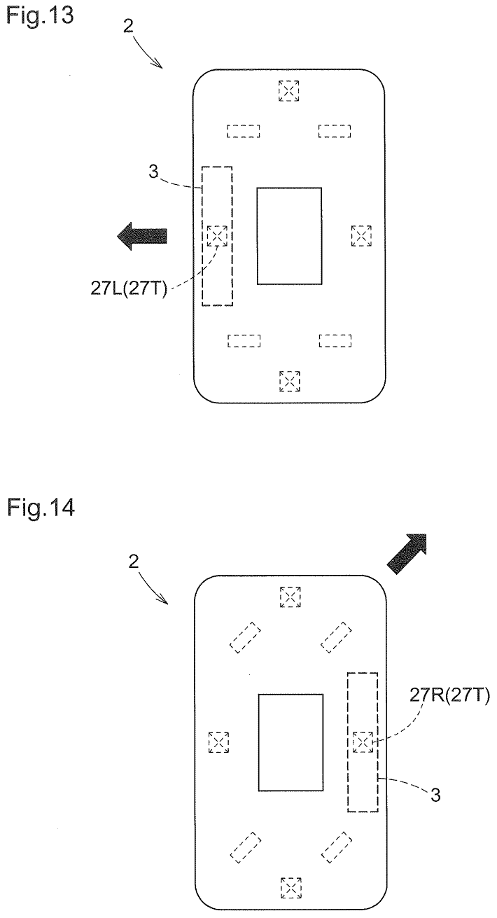

FIG. 13 shows an example of a case where the carriage 2 travels transversely leftward. For example, this corresponds to a case where the carriage 2 travels along the second transverse section P42 of the bypass section P4 in the example shown in FIG. 1.

As shown in FIG. 13, in a case where the carriage 2 travels transversely leftward (in other words, in a case where the controller 4 is to cause the automated transport vehicle 3 to move the carriage 2 transversely leftward), the controller 4 determines, from among the plurality of engagement sections 27, the left engagement section 27L, which is the engagement section 27 located closer to the moving direction during the transverse traveling, as the target engagement section 27T. Then, the automated transport vehicle 3 is coupled to the carriage 2 at a position on the left side of the body 21. In the example shown in FIG. 12, the automated transport vehicle 3 entirely overlaps the carriage 2 in plan view in a state in which the engaging section 37 is engaged with the left engagement section 27L provided on the body 21, and in which the longitudinal direction of the automated transport vehicle 3 extends in the front-rear direction of the carriage 2.

FIG. 14 shows an example of a case where the carriage 2 travels obliquely rightward and forward. As shown in this drawing, in a case where the carriage 2 travels obliquely rightward and forward (in other words, in a case where the controller 4 is to cause the automated transport vehicle 3 to move the carriage 2 obliquely rightward and forward), the controller 4 determines, from among the plurality of engagement sections 27, the right engagement section 27R, which is the engagement section 27 located closer to the moving direction during the oblique traveling, as the target engagement section 27T. Then, the automated transport vehicle 3 is coupled to the carriage 2 at a position on the right side of the body 21. In the example shown in FIG. 14, the automated transport vehicle 3 entirely overlaps the carriage 2 in plan view in a state in which the engaging section 37 is engaged with the right engagement section 27R provided on the body 21, and in which the longitudinal direction of the automated transport vehicle 3 extends in the front-rear direction of the carriage 2.

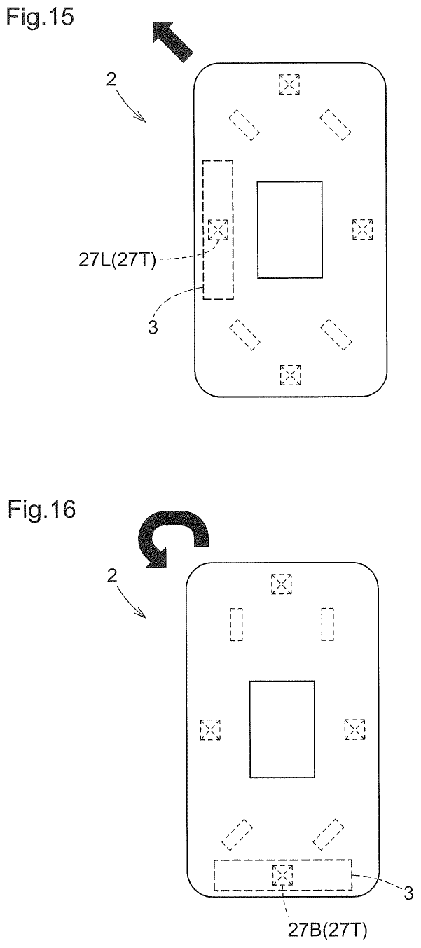

FIG. 15 shows an example of a case where the carriage 2 travels obliquely leftward and forward. As shown in this drawing, in a case where the carriage 2 travels obliquely leftward and forward (in other words, in a case where the controller 4 is to cause the automated transport vehicle 3 to move the carriage 2 obliquely leftward and forward), the controller 4 use, from among the plurality of engagement sections 27, the left engagement section 27L, which is the engagement section 27 located closer to the moving direction during the oblique traveling, as the target engagement section 27T. Then, the automated transport vehicle 3 is coupled to the carriage 2 at a position on the left side of the body 21. In the example shown in FIG. 15, the automated transport vehicle 3 entirely overlaps the carriage 2 in plan view in a state in which the engaging section 37 is engaged with the left engagement section 27L provided on the body 21, and in which the longitudinal direction of the automated transport vehicle 3 extends in the front-rear direction of the carriage 2.

FIG. 16 shows an example of a case where the carriage 2 travels to make a short turn at a radius of curvature greater than or equal to a reference radius of curvature. Here, the reference radius of curvature is set to a length of about 0.3 to 2 m, for example. The reference radius of curvature may have a fixed value, or a variable value that varies depending on the situation.

As shown in FIG. 16, in a case where the carriage 2 travels to make a short turn at a radius of curvature less than or equal to the predetermined reference radius of curvature (in other words, in a case where the controller 4 is to cause the automated transport vehicle 3 to move the carriage 2 to make a short turn at a radius of curvature less than or equal to the predetermined reference radius of curvature), the controller 4 determines, from among the plurality of engagement sections 27, the rear engagement section 27B as the target engagement section 27T. Then, the automated transport vehicle 3 is coupled to the carriage 2 at a position on the rear side of the body 21. In the example shown in FIG. 16, the automated transport vehicle 3 entirely overlaps the carriage 2 in plan view in a state in which the engaging section 37 is engaged with the rear engagement section 27B provided on the body 21, and in which the longitudinal direction of the automated transport vehicle 3 extends in the left-right direction of the carriage 2.

The controller 4 is configured to obtain information relating to the transport path P. Based on the obtained information relating to the transport path P, the controller 4 can timely select the target engagement section 27T, and timely change the coupling position between the automated transport vehicle 3 and the carriage 2.

Note that the controller 4 may be configured to obtain, in addition to the information relating to the transport path P, information relating to the transport load within the transport path P. Here, the information relating to the transport load includes information relating to the material and the inclination of the floor surface F, information relating to the delivery and receipt of the placement target object B to and from other transport apparatuses, information relating to the weight increase of the placement target object B due to mounting of parts, and so forth. The controller 4 may select the target engagement section 27T suitable for transport at a location where a relatively large load is required, also taking the obtained information relating to the transport path P into consideration.

### OTHER EMBODIMENTS

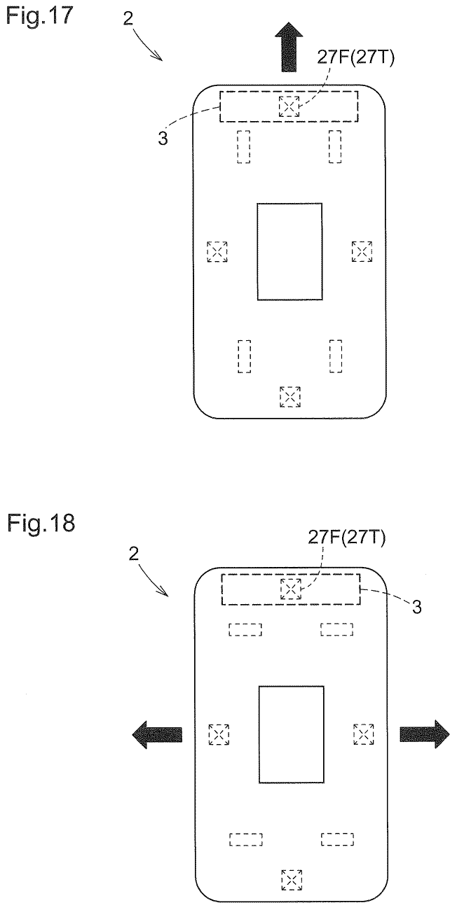

(1) The foregoing embodiment has described, as an example, a configuration in which, in a case where the carriage 2 travels straight at a speed less than a reference speed, the controller 4 determines, from among the plurality of engagement sections 27, either the right engagement section 27R or the left engagement section 27L as the target engagement section 27T. However, the present disclosure is not limited to such a configuration. In such a case, as shown in FIG. 17, for example, the controller 4 may determine, from among the plurality of engagement sections 27, the front engagement section 27F as the target engagement section 27T. In the example shown in FIG. 17, the automated transport vehicle 3 entirely overlaps the carriage 2 in plan view in a state in which the engaging section 37 is engaged with the front engagement section 27F provided on the body 21, and in which the longitudinal direction of the automated transport vehicle 3 extends in the left-right direction of the carriage 2.

(2) The foregoing embodiment has described, as an example, a configuration in which, in a case where the carriage 2 travels transversely rightward or leftward, the controller 4 determines, from among the plurality of engagement sections 27, the engagement section 27 located to closer to the moving direction during the transverse traveling, as the target engagement section 27T. However, the present disclosure is not limited to such a configuration. In such a case, as shown in FIG. 18, for example, the controller 4 may determine, from among the plurality of engagement sections 27, the front engagement section 27F as the target engagement section 27T. In this case, the front engagement section 27F may be unconditionally used as the target engagement section 27T, or the front engagement section 27F may be used as the target engagement section 27T, for example, on condition that the carriage 2 travels transversely at a speed less than a predetermined low speed. The low speed may be set to a speed of about 5 to 15 m/min, for example. The low speed may have a fixed value, or a variable value that varies depending on the situation. In the example shown in FIG. 18, the automated transport vehicle 3 entirely overlaps the carriage 2 in plan view in a state in which the engaging section 37 is engaged with the front engagement section 27F provided on the body 21, and in which the longitudinal direction of the automated transport vehicle 3 extends in the left-right direction of the carriage 2.

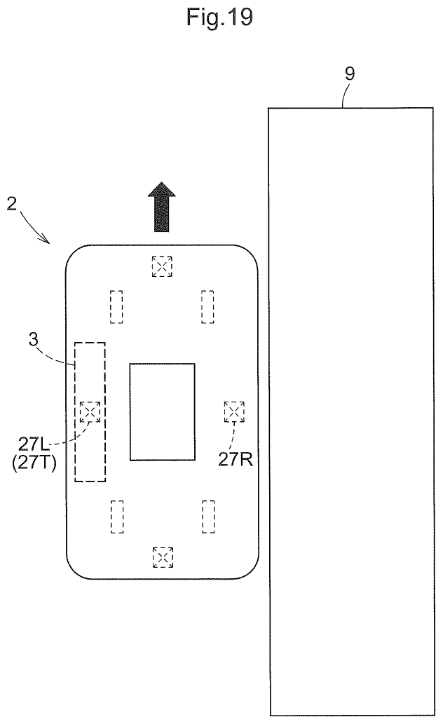

(3) The foregoing embodiment has described, as an example, a configuration in which the controller 4 determines the target engagement section 27T from among the plurality of engagement sections 27, according to the movement mode of the carriage 2. However, the present disclosure is not limited to such a configuration. For example, the controller 4 may determine the target engagement section 27T according to the state of the carriage 2. As shown in FIG. 19, for example, in a case where the carriage 2 travels along a platform 9 for performing various operations such as loading and unloading of packages, and assembling of parts, the controller 4 may determine, from among the plurality of engagement sections 27, the engagement section 27 (the left engagement section 27L in the illustrated example) located further from the platform 9 as the target engagement section 27T. For example, in a case where there is an imbalance in the weight of the placement target object B placed on the carriage 2, the controller 4 may use, from among the plurality of engagement sections 27, an engagement section 27 located in the vicinity of at a position at which the surface pressure is relatively high as the target engagement section 27T. Note that the controller 4 may take the state and the movement mode of the carriage 2 into consideration, and determine the target engagement section 27T according to both of them.

(3) The foregoing embodiment has described, as an example, a configuration in which the engagement sections 27 are provided outside a region surrounded by the four wheels 24 in plan view. However, the present disclosure is not limited to such a configuration. For example, in a case where the four wheels 24 are provided at peripheral edges (typically, four corners) of the placement table 22, the engagement sections 27 may be provided inside a region surrounded by the four wheels 24 in plan view.

(4) The foregoing embodiment has described, as an example, a configuration in which each of the engagement sections 27 is constituted by a set of four pin engaging holes 28 arranged side by side in the front-rear direction and the left-right direction, and the coupling orientation between the automated transport vehicle 3 and the carriage 2 is switchable between a longitudinal orientation and a transverse orientation. However, the present disclosure is not limited to such a configuration. Each of the engagement sections 27 may be constituted by a set of two pin engaging holes 28. For example, the right engagement section 27R and the left engagement section 27L are each constituted by a set of two pin engaging holes 28 arranged side by side in the front-rear direction, and the coupling orientation between the automated transport vehicle 3 and the carriage 2 at the positions of the pin engaging holes 28 may uniformly be in a longitudinal orientation. For example, the front engagement section 27F and the rear engagement section 27B may each be constituted by a set of two pin engaging holes 28 arranged side by side in the left-right direction, and the coupling orientation between the automated transport vehicle 3 and the carriage 2 at the positions of the pin engaging holes 28 may uniformly be in a transverse orientation. Alternatively, the front engagement section 27F and the rear engagement section 27B may each be constituted by a set of two pin engaging holes 28 arranged side by side in the front-rear direction.

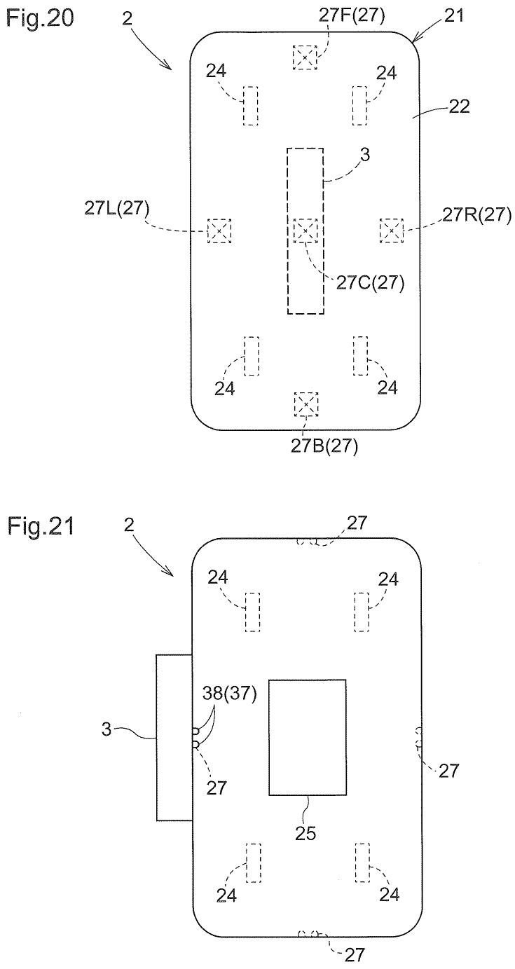

(5) The foregoing embodiment has described, as an example, a configuration in which the four engagement sections 27 are provided separately on the front, rear, left, and right sides of the body 21. However, the present disclosure is not limited to such a configuration. For example, two engagement sections 27 may be provided separately on the left and right sides, or the front and rear sides of the body 21, or three engagement sections 27 may be provided separately on the front or rear side and the left and right sides of the body 21. Alternatively, as shown in FIG. 20, for example, in a case where the lifting device 25 is not provided at a central portion of the body 21, five engagement sections 27 may be provided separately at a central portion, and the front, rear, left, and right sides of the body 21. In this case, the engagement section 27 provided at the central portion of the body 21 can be referred to as a “central engagement section 27C”. Six or more engagement sections 27 may be provided on the body 21.

(6) The foregoing embodiment has described, as an example, a configuration in which the engagement sections 27 are provided on the carriage 2 n such a manner as to face downward, and the engaging section 37 is provided on the automated transport vehicle 3 in such a manner as to be vertically movable. However, the present disclosure is not limited to such a configuration. For example, as shown in FIG. 21, engagement sections 27 may be provided on the body 21 in such a manner as to face sideward, and an engaging section 37 may be provided on the automated transport vehicle 3 in such a manner as to be engaged with the engagement sections 27. In a case where the height of the main unit 32 of the automated transport vehicle 3 is greater than or equal to the height of the placement table 22 of the carriage 2, the engaging section 37 may be provided in such a manner as to be projectable and retractable in the horizontal direction relative to the main unit 32 of the automated transport vehicle 3. In a case where the height of the main unit 32 of the automated transport vehicle 3 is less than the height of the placement table 22 of the carriage 2, the engaging section 37 may be provided in such a manner as to be pivotable from the main unit 32 of the automated transport vehicle 3 while facing sideward. In these cases, the engaging section 37 may be non-projectable and non-retractable, or non-pivotable, and simply the engaging section 37 may be engaged with the engagement sections 27 in association with movement and a direction change of the automated transport vehicle 3.

(7) The configurations disclosed in the embodiments described above (including the above-described embodiment and other embodiments; the same applies to the following) are applicable in combination with configurations disclosed in other embodiments so long as no inconsistency arises. With regard to the other configurations as well, the embodiments disclosed herein are in all respects as illustrative, and appropriate changes and modifications may be made thereto without departing from the scope and sprit of the present disclosure.

### Outline of the Embodiment

To summarize the foregoing, preferably, a transport facility according to the present disclosure includes the following configurations.

A transport facility includes:
a carriage;
an automated transport vehicle configured to be coupled to the carriage to move the carriage; and
a controller configured to control an operation of the automated transport vehicle, wherein
the carriage includes a body, and engagement sections provided separately at a plurality of locations of the body,
the automated transport vehicle includes an engaging section configured to be engaged with one of the plurality of engagement sections for coupling between the automated transport vehicle and the carriage, and
the controller determines, according to at least either a state of the carriage or a movement mode of the carriage, a target engagement section serving as the engagement section with which the engaging section is to be engaged, from among the plurality of engagement sections.

With this configuration, the engagement sections of the carriage are provided separately at a plurality of locations of the body, a target engagement section is determined from among the plurality of engagement sections, and the engaging section of the automated transport vehicle is engaged with the target engagement section. In determining the target engagement section, either or both the state and the movement mode of the carriage are taken into consideration. For example, in relation to the moving direction, the movement speed, the traveling state, and so forth of the carriage, the carriage and the automated transport vehicle can be easily coupled at an optimal position in terms of efficient driving power transmission. This allows the driving force of the automated transport vehicle to be appropriately transmitted to the carriage according to at least either the state or the movement mode of the carriage. Thus, it is possible to efficiently move a carriage in a transport facility having a configuration in which the carriage is moved by an automated transport vehicle.

As an aspect,
it is preferable that the engagement sections are provided separately on front, rear, left, and right portions of the body.

With this configuration, by providing engagement sections in four locations on the front, rear, left, and right portions of the body, the range of selection for the coupling position between the carriage and the automated transport vehicle can be effectively increased using as few number of parts as possible.

As an aspect,
it is preferable that, in a case where the carriage travels rightward or leftward along a curve, the controller determines, out of the engagement sections provided on the left and right portions of the body, the engagement section located opposite to a direction of the curve as the target engagement section.

With this configuration, in a case where the carriage travels along a curve, the carriage can travel along the curve using a force acting on the carriage in the left-right direction from the automated transport vehicle. Accordingly, it is possible to appropriately transmit the driving force of the automated transport vehicle to the carriage, thus efficiently moving the carriage.

As an aspect,
it is preferable that, even in a case where the carriage travels rightward or leftward along a curve, in a case where the carriage travels at a speed greater than or equal to a predetermined reference speed, the controller determines, in place of the engagement section provided on the left and right portions of the body, the engagement section provided on the front portion of the body as the target engagement section.

With this configuration, in a case where the carriage travels along a curve at a relatively high speed that is greater than or equal to a reference speed, the automated transport vehicle is coupled to the front portion of the body to tow the carriage. Accordingly, it is possible to appropriately transmit the driving force of the automated transport vehicle to the carriage, thus efficiently moving the carriage while ensuring the steerability of the carriage.

As an aspect,
it is preferable that, in a case where the carriage travels transversely rightward or leftward, or travels obliquely in a leftward and forward direction or a rightward and forward direction, the controller determines, out of the engagement sections provided on the left and right portions of the body, the engagement section located closer to a moving direction during the transverse traveling or the oblique traveling as the target engagement section.

With this configuration, in a case where the carriage travels transversely or travels obliquely, the carriage is towed on the leading portion in the moving direction. Accordingly, it is possible to appropriately transmit the driving force of the automated transport vehicle to the carriage, thus efficiently performing the transverse traveling or the oblique traveling while ensuring the steerability of the carriage.

As an aspect,
it is preferable that, in a case where the carriage travels straight at a speed greater than or equal to a predetermined reference speed, the controller determines the engagement section provided on the front portion of the body as the target engagement section.

With this configuration, in a case where the carriage travels straight at a relatively high speed that is greater than or equal to a reference speed, the carriage is towed on the front portion of the body. Accordingly, it is possible to appropriately transmit the driving force of the automated transport vehicle to the carriage, thus efficiently performing the high-speed straight traveling while ensuring the straight traveling stability of the carriage.

As an aspect,
it is preferable that, in a case where the carriage travels to make a short turn at a radius of curvature less than or equal to a predetermined reference radius of curvature, the controller determines the engagement section provided on the rear portion of the body as the target engagement section.

With this configuration, in a case where the carriage travels to make a short turn at a radius of curvature less than or equal to predetermined reference radius of curvature, the carriage is steered on the rear portion of the body. Accordingly, it is possible to appropriately transmit the driving force of the automated transport vehicle to the carriage, thus ensuring the turning performance of the carriage, and allowing the carriage to appropriately travel to make a short turn.

As an aspect,
it is preferable that the automated transport vehicle is elongated in plan view,
the automated transport vehicle entirely overlaps the carriage in plan view in a case where the engaging section is engaged with one of the engagement sections provided on the left and right portions of the body, and where a longitudinal direction of the automated transport vehicle extends in a front-rear direction of the carriage, and
the automated transport vehicle entirely overlaps the carriage in plan view in a case where the engaging section is engaged with one of the engagement sections provided on the front and rear portions of the body, and where the longitudinal direction of the automated transport vehicle extends in a left-right direction of the carriage.

With this configuration, the automated transport vehicle entirely fits within the space below the carriage and does not protrude therefrom. Therefore, a space in which the automated transport vehicle travels does not need to be provided outward of the carriage. Accordingly, it is possible to minimize a surplus space provided around the movement trajectory of the carriage, thus facilitating a reduction in the overall size of the transport facility.

Note that in a case where one of the engagement sections provided on the left and right portions of the body is used as the target engagement section, and the automated transport vehicle is entirely overlapped with the carriage in plan view by causing the longitudinal direction of the automated transport vehicle to extend in the front-rear direction of the carriage, the following effect can be additionally achieved. That is, in a case where the carriage to which the automated transport vehicle is to be coupled is switched in a case where a plurality of carriages travel in lines, the switching can be smoothly performed by moving the automated transport vehicle using the space located below each of the carriages. The switching of the carriage to which the automated transport vehicle is to be coupled can be smoothly performed while transporting the plurality of carriages in contact with each other without any gap therebetween in the front-rear direction, to form a continuous floor surface, for example, on the upper surfaces of the carriages, and allowing an operator or the like to walk on the floor surface.

As an aspect,
it is preferable that the engagement sections are provided on the body in such a manner as to face downward, and the engaging section is provided in such a manner as to be vertically movable relative to a main unit of the automated transport vehicle.

With this configuration, in a case where the engagement sections are provided in such a manner as to face downward, the engaging section is vertically moved relative to the main unit of the automated transport vehicle, thus making it possible to appropriately couple and decouple the carriage and the automated transport vehicle to and from each other. Furthermore, with this configuration, it is possible to press the automated transport vehicle against the floor surface located therebelow, using the reaction force generated when the engaging section is lifted for coupling, thus ensuring a significant amount of friction force between the wheels of the automated transport vehicle and the floor surface. Thus, it is possible to secure a significant amount of propelling force generated by the automated transport vehicle.

As an aspect,
it is preferable that the engagement sections are provided on the body in such a manner as to face sideward, and the engaging section is provided in such a manner as to be projectable and retractable in a horizontal direction relative to a main unit of the automated transport vehicle.

With this configuration, in a case where the engagement sections are provided in such a manner as to face sideward, the engaging section is projected and retracted in the horizontal direction relative to the main unit of the automated transport vehicle, thus making it possible to appropriately couple and decouple the carriage and the automated transport vehicle to and from each other.

As an aspect,
it is preferable that, in a case where the carriage travels along a platform, the controller determines, out of the engagement sections provided on the left and right portions of the body, the engagement section located further from the platform as the target engagement section.

This configuration allows easy access to the automated transport vehicle in a case where the carriage travels along the platform. Accordingly, inspection and repair can be easily performed, for example, when the carriage traveling along the platform has stopped due to abnormality or the like of the automated transport vehicle.

It is sufficient that the transport facility according to the present disclosure can achieve at least one of the above-described effects.

### DESCRIPTION OF REFERENCE SIGNS

1: Transport facility
2: Carriage
3: Automated transport vehicle
4: Control unit
9: Platform
21: Body
22: Placement table
23: Support column
24: Wheel
25: Lifting device
27: Engagement section
27F: Front engagement section
27B: Rear engagement section
27R: Right engagement section
27L: Left engagement section
27C: Central engagement section
27T: Target engagement section
28: Pin engaging hole
31: Body
32: Main unit
33: Drive unit
34: Driving wheel
35: Auxiliary wheel
37: Engaging section
38: Lifter
39: Engaging pin
P: Transport path
P1: First straight section
P2: Second straight section
P3: Curved section
P4: Bypass section
P41: First transverse section
P42: Second transverse section
P43: Straight section
F: Floor surface
B: Placement target object

1. A transport facility, comprising:
a carriage;
an automated transport vehicle configured to be coupled to the carriage to move the carriage; and
a controller configured to control an operation of the automated transport vehicle, and wherein:
the carriage comprises a body, and engagement sections provided separately at a plurality of locations of the body,
the automated transport vehicle comprises an engaging section configured to be engaged with one of the plurality of engagement sections for coupling between the automated transport vehicle and the carriage, and
the controller determines, according to at least either a state of the carriage or a movement mode of the carriage, a target engagement section serving as the engagement section with which the engaging section is to be engaged, from among the plurality of engagement sections.

2. The transport facility according to claim 1, wherein the engagement sections are provided separately on front, rear, left, and right portions of the body.

3. The transport facility according to claim 2, wherein, in a case where the carriage travels rightward or leftward along a curve, the controller determines, out of the engagement sections provided on the left and right portions of the body, the engagement section located opposite to a direction of the curve as the target engagement section.

4. The transport facility according to claim 3, wherein, even in a case where the carriage travels rightward or leftward along a curve, in a case where the carriage travels at a speed greater than or equal to a predetermined reference speed, the controller determines, in place of the engagement section provided on the left and right portions of the body, the engagement section provided on the front portion of the body as the target engagement section.

5. The transport facility according to claim 2, wherein, in a case where the carriage travels transversely rightward or leftward, or travels obliquely in a leftward and forward direction or a rightward and forward direction, the controller determines, out of the engagement sections provided on the left and right portions of the body, the engagement section located closer to a moving direction during the transverse traveling or the oblique traveling as the target engagement section.

6. The transport facility according to claim 2, wherein, in a case where the carriage travels straight at a speed greater than or equal to a predetermined reference speed, the controller determines the engagement section provided on the front portion of the body as the target engagement section.

7. The transport facility according to claim 2, wherein, in a case where the carriage travels to make a short turn at a radius of curvature less than or equal to a predetermined reference radius of curvature, the controller determines the engagement section provided on the rear portion of the body as the target engagement section.

8. The transport facility according to claim 2, wherein:
the automated transport vehicle is elongated in plan view,
the automated transport vehicle entirely overlaps the carriage in plan view in a case where the engaging section is engaged with one of the engagement sections provided on the left and right portions of the body, and where a longitudinal direction of the automated transport vehicle extends in a front-rear direction of the carriage, and
the automated transport vehicle entirely overlaps the carriage in plan view in a case where the engaging section is engaged with one of the engagement sections provided on the front and rear portions of the body, and where the longitudinal direction of the automated transport vehicle extends in a left-right direction of the carriage.

9. The transport facility according to claim 2, wherein the engagement sections are provided on the body in such a manner as to face downward, and the engaging section is provided in such a manner as to be vertically movable relative to a main unit of the automated transport vehicle.

10. The transport facility according to claim 2, wherein the engagement sections are provided on the body in such a manner as to face sideward, and the engaging section is provided in such a manner as to be projectable and retractable in a horizontal direction relative to a main unit of the automated transport vehicle.

11. The transport facility according to claim 2, wherein, in a case where the carriage travels along a platform, the controller determines, out of the engagement sections provided on the left and right portions of the body, the engagement section located further from the platform as the target engagement section.
